(19) United States
(12) Patent Application Publication
(10) Pub. No.: US 2008/0291901 A1
(43) Pub. Date: Nov. 27, 2008

(54) Network architecture for call processing

(76) Inventors: Nathan Allan Stratton, Katy, TX (US); David Epstein, Hartford, CT (US)

Correspondence Address: BINGHAM MCCUTCHEN LLP, 2020 K Street, N.W., Intellectual Property Department, WASHINGTON, DC, 20006, US

(21) Appl. No.: 12/149,734

(22) Filed: May 7, 2008

Related U.S. Application Data
(60) Provisional application No. 60/924,298, filed on May 8, 2007.

(51) Int. Cl. H04L 12/66

(52) U.S. Cl. 370/352

(57) ABSTRACT

A network system for call processing, including customer premises equipment originating a call across a network, wherein the call includes private and public information; a session border controller directing the call information from the customer premises equipment to a public switched telephone network gateway, wherein the session border controller parses out the private information from the call information transmitted to the gateway; and one or more servers coupled to the session border controller, routing only the non-private call information to the public switched telephone network gateway.

### CROSS-REFERENCE TO RELATED APPLICATION

This application is based upon and claims priority from U.S. provisional patent application No. 60/924,298, filed May 8, 2007, the contents of which being incorporated herein by reference.

### BACKGROUND

Voice, data, and multi-media communication between and among devices across a network often involve the exchange of information that some users consider private, such as Internet Protocol (IP) addresses. There is a need to establish and implement a network architecture and/or system that will permit seamless use of network communications while keeping private information from the public portions of the network.

### SUMMARY

Exemplary embodiments are directed to a network system for call processing, including customer premises equipment originating a call across a network, wherein the call includes private and public information; a session border controller directing the call information from the customer premises equipment to a public switched telephone network gateway, wherein the session border controller parses out the private information from the call information transmitted to the gateway; and one or more servers coupled to the session border controller, routing only the non-private call information to the public switched telephone network gateway.

Alternate embodiments are directed to a computer-implemented system and method for processing calls across a network, including initiating a call from customer premises equipment; directing the call through a first session border controller, wherein the first session border controller blocks transmission of call private information; transmitting the non-private call information through one or more servers of a private network to a second session border controller; and forwarding the non-private call information from the second session border controller to a public switched telephone network gateway, wherein the second session border controller blocks the address of the public switched telephone network gateway from the private network.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 shows a computer-implemented network architecture for providing communication services, including packetized voice communications.

FIG. 2 shows an illustrative example of call messaging involving each of the network elements of FIG. 1, including the routing server, for an outbound call.

FIG. 3 shows an additional network diagram for handling calls across a private network between public network-connected devices.

FIG. 4 shows private connections to a public communications network while keeping private information out of the public network.

FIG. 5 shows a network scheme whereby an attempted outbound call fails.

FIG. 6 shows a network scheme whereby an attempted inbound call fails.

FIG. 7 shows a network scheme whereby an attempted inbound call succeeds.

### DETAILED DESCRIPTION OF THE EMBODIMENTS

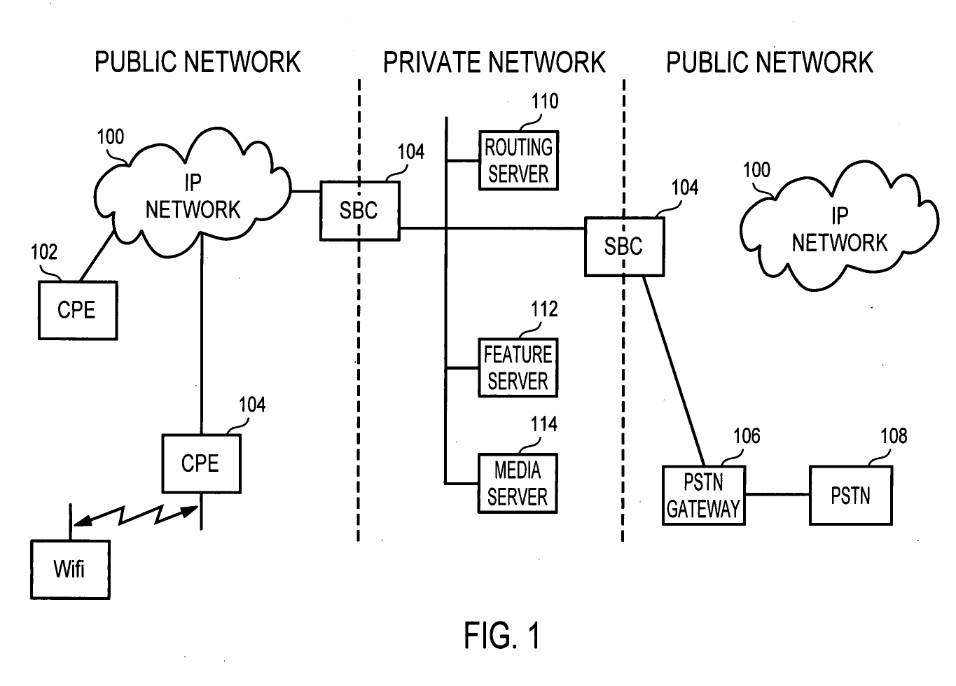

Referring initially to FIG. 1, there is illustrated a computer-based network architecture for providing communication, including, but not limited to, packetized voice communications. While exemplary embodiments are described below for voice over IP (VoIP) systems, the system and method of the invention are not so limited. Embodiments of the invention can be easily extended by persons of skill in the art, in conjunction with the present description of the invention, to provide a variety of voice, communications, and network services.

These and other aspects of call processing network architecture will now be described in greater detail in connection with a number of exemplary embodiments. To facilitate an understanding of the embodiments, many aspects are described in terms of sequences of actions to be performed by elements of a computer system or apparatus as shown in FIG. 1. It will be recognized that in each of the embodiments, the various actions could be performed by specialized circuits, by computer program or computer product instructions being executed by one or more processors, or by a combination of both. Moreover, embodiments can additionally be considered to be embodied entirely within any form of computer readable storage medium having stored therein an appropriate set of computer instructions that would cause a processor to carry out the techniques, methods, and steps described herein.

Referring again to FIG. 1, there is shown a computer-implemented network architecture for providing communication. The customer premises equipment (CPE) 102 is coupled to a public switched telephone network (PSTN) gateway 106 through one or more session border controllers (SBC's) 104. A key function of the SBC 104 is to isolate the public network from the private network elements by parsing out private information from being transmitted to the PSTN gateway 106. Other SBC functions can include, but are not limited to, providing network address translation, security, traffic shaping, and Quality of Service (QoS) monitoring. The CPE 102 includes, but is not limited to, personal computers, analog telephone adapters, personal digital assistants, WiFi terminals, and/or IP phones. Communication between the CPE 102 and the SBC 104 is done according to a communication protocol in which control messages are separate from voice data, such as the session initiation protocol (SIP) protocol, though other protocols can be used. The voice data is generally transmitted according to a real time protocol (RTP). However, in addition to carrying voice data, the system and methods described here are equally applicable to carrying calls, statistics, messages, video, data, images and other types of media or communications, including multi-media.

According to one embodiment, SIP messaging and RTP are used to establish and carry telephone calls via a public network 100, such as but not limited to the Internet and a private network to and from the PSTN 108 as shown. This configuration allows calls to be established between a telephone on the PSTN 108 and a CPE 102 that is accessible via the Internet 100, between a CPE 102 that is accessible only through the Internet 100 or a LAN/WAN type of system or a terminal device such as a CPE 102 or a PSTN telephone 108 and a network-attached device such as a voice mail system.

Still referring to FIG. 1, one of the SBC's 104 is dedicated to the CPE 102, and messaging in the forward and reverse directions between the CPE 102 and the SBC 104 does not change regardless of how the call is handled by the private network. In addition, the CPE 102 does not receive an address of any public elements, such as a PSTN gateway 106, because the CPE 102 does not communicate directly with any public elements; and the SBC 104 shields the CPE 102 from further information about the call set up. In addition, in call forwarding scenarios, the CPE 102 never learns through SIP messaging the forwarded telephone number or network address for the call destination. The CPE 102 can be programmed with an IP address of one or more SBC's 104 which the CPE 102 uses to establish communication with an appropriate SBC 104. The CPE 102 can alternatively use a domain name and a domain name server to find a SBC 104; however, this is not required.

The second SBC 104 can be dedicated to PSTN connectivity. This can include directly connecting to a PSTN gateway 106 to provide PSTN access. An alternative embodiment provides for PSTN connectivity for the SBC 104 to connect via SIP or another protocol over an IP network 100. The SIP messaging in the forward and reverse directions between the PSTN 108 and the SBC 104 does not change regardless of call forwarding or call handling. In call forwarding scenarios, the PSTN elements 108 never learn the forwarded telephone number or network address for the call through SIP messaging.

Any “name translations” occur at private network elements situated between SBC's 104, but the translated names, such as destination telephone numbers or network addresses for VoIP subscribers, are not backward propagated to any public elements, such as a CPE 102 or a PSTN gateway 106. In these scenarios, the network path between the private side of the SBC's 104 is a private network path that can be provided using dedicated circuits, virtual private network (VPN) tunnels, or any other private network technology.

A feature server 112, a routing server 110, and a media server 114 can be coupled to the private data network and are coupled to the SBC's 104. The routing server maintains information used to route telephone calls to the PSTN 108 or to various CPE's 102 or network elements. For example, the routing 110 server can include a port address on the SBC 104 that leads to each PSTN gateway 106. Moreover, the routing server 110 can correlate destination telephone numbers with different PSTN gateways 106. Outbound calls that enter the private network through a SBC 104 and then reach the routing server 110, for example, with a SIP INVITE message. The routing server 110 can respond with a message that identifies the port of the SBC 104 that leads to a desired PSTN gateway 106 to handle the call.

The feature server 112 includes an application that facilitates call processing. The feature server 112 generally includes software that allows callers to configure calling options such as call forwarding and ring over to voice mail. The software further can be configured to allow interaction through the Internet 100 with subscribers to allow subscribers to update and configure calling options. Such services can include services traditionally provided on the PSTN 108 such as call forwarding, call waiting, voicemail, distinctive ring, etc. The feature server 112 can also provide newer enhanced services such as voicemail to email, video conferencing, or custom call routing. In addition, the feature server 112 together with the SBC 104 can authenticate CPE's 102 and callers as authorized to use the system.

A media server 114 can be implemented to include an interactive voice response unit (IVRU) and a storage server, such as an email server. The media server 114 can implement a voice mail function, allowing incoming calls to be connected to voice mail under a variety of conditions, including when the caller is unavailable. In these scenarios, the feature server 112 receives the call messaging and data associated with the call, such as the calling and/or called telephone number. The media server 114 receives the RTP part of the call and plays messages into the call and records messages from callers. The feature server 112 receives information from the call and passes that information to the media server 114 through a separate data link, which can also use standard communications protocols such as SIP. Ultimately, messages are stored in the media server 114 and/or its associated email server together with information pertaining to the call. This information can be provided to callers via email, or a web portal in any convenient manner. Alternatively, subscribers can call in to check voicemail using a telephone and retrieve information regarding messages by interacting with the IVRU.

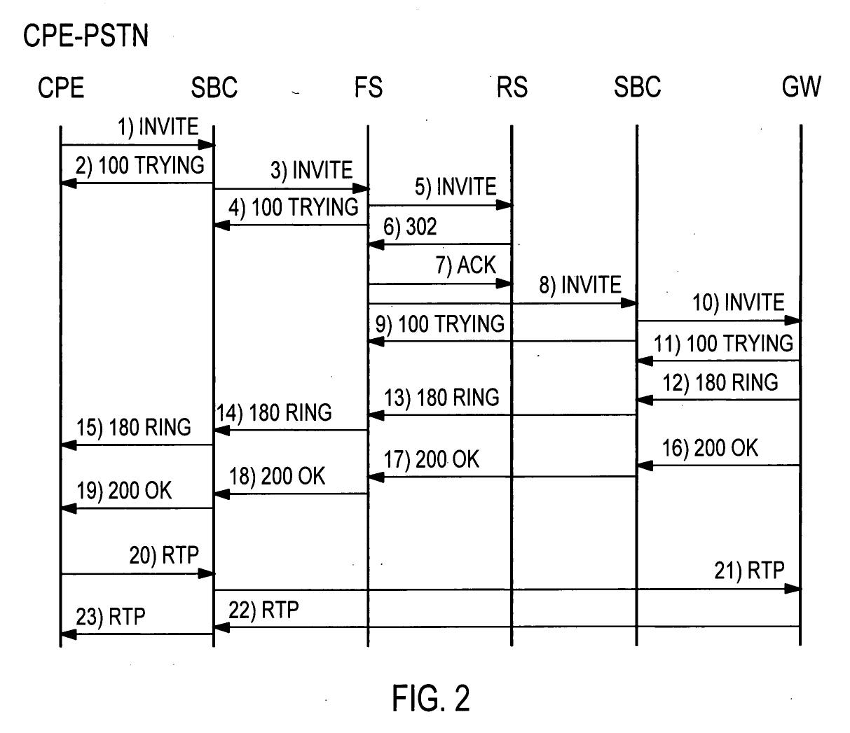

An illustrative example of call messaging involving each of the network elements, including the routing server 110, for an outbound call is shown in FIG. 2, with the numbered steps of FIG. 2 corresponding to the numbered steps below.

1) When a call is originated from the CPE 102, a SIP INVITE message is sent to the SBC 104 that the CPE 102 has been configured to use. The CPE 102 only has the ability to communicate with the public side of the SBC 104 and has no knowledge of the private internal network.

2) The SBC 104 sends back a SIP 100 Trying message from the public side of the SBC 104 to the CPE 102, which indicates that the SBC 104 is working to complete the call.

3) The SBC 104 can send the call to a feature server that will be used to process the call, alternatively the SBC 104 may be configured to send the call to a routing server that may be used to determine the correct feature server 112 to use. All communication from the SBC 104 to the FS is done on the private network.

4) The feature server 112 sends back a 100 Trying to the SBC 104 and continues to process the call.

5) In order for the call to be sent to the PSTN 108, the feature server 112 sends a SIP INVITE to the routing server 110 to determine where the call should be sent.

6) The routing server 110 responds with a SIP 302. In this message includes one or more IP addresses of SBC's 104 that may be used to terminate the call.

7) The feature server 112 acknowledges the receipt of the SIP 302 by sending back an acknowledgement code (ACK).

8) A INVITE may now be sent from the feature server 112 to a SBC 104 that will be used to terminate the call. The feature server 112 has no knowledge of the public network behind the SBC 104.

9) The SBC 104 sends back a 100 Trying, indicating call progress.

10) On the public side of the network, the SBC 104 sends the call over an IP network to a PSTN gateway 106 or alternate provider to terminate the call.

11) The PSTN gateway 106 or PSTN provider sends back a 100 Trying, indicating call progress.

12) A SIP 180 can be sent back to indicate that the phone is ringing on the remote party side.

13) The SBC alerts the feature server 112 of the remote ringing.

14) The feature server 112 alerts the SBC 104 of the remote ringing.

15) The SBC 104 alerts the CPE 102 of the remote ringing.

16) A SIP 200 OK message is sent to the public side of the SBC 104, indicating that the call has been picked up.

17) A 200 OK is sent to the feature server 112.

18) A 200 OK sent to the SBC 104.

19) A 200 OK sent to the CPE 102.

20) The CPE 102 starts sending media to the public side of the SBC 104.

21) Media from the SBC 104 is sent to the SBC 104 used by the PSTN 108 on the private network and then to the PSTN element on the public network. The CPE 102 is totally shielded and has no knowledge of the IP addresses of the PSTN elements.

22) The PSTN element starts sending media to the public side of the SBC 104, and as with the media from the CPE 102, is sent across the private network and then back to the CPE 102 on the public network. The PSTN elements have no knowledge of any IP addresses of the CPE 102.

The Internet presently is comprised of IP version 4 (v4) addresses for uniquely identifying devices connected to and/or communicating with the Internet. Initially, a 32 bit address was considered to be large enough to identify every device that would ever be connected to the Internet. In the early 1990's, it became clear that that the IP v4 address space would not be sufficient, and IP v6 was created with 128 bit addresses, allowing for the potential of every light bulb on the earth to be connected to the Internet. This transition to v6 has been much slower then planned; and, accordingly, service providers in need of a technique to save IP addresses have begun using Network Address Translation (NAT). IP address blocks such as, for example and not limitation, 10.0.0.0-10.255.255.255, 172.16.0.0-172.31.255.255, and 192.168.0.0-192.168.255.255 are used for private networks. Unlike other IP addresses, they are used over and over again on private networks and are not routable directly on the public Internet.

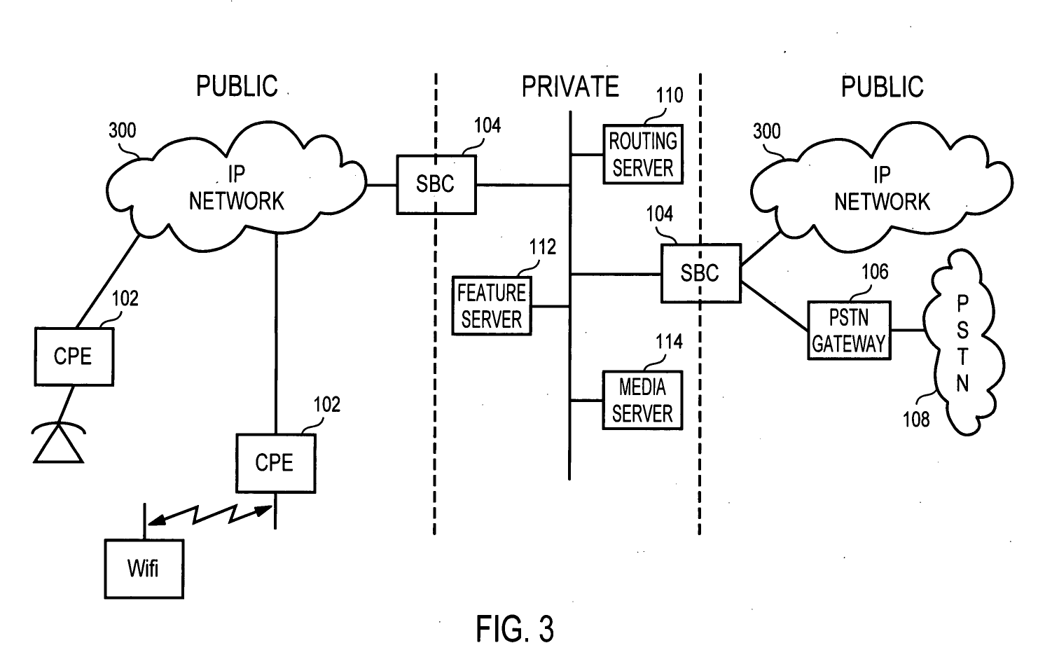

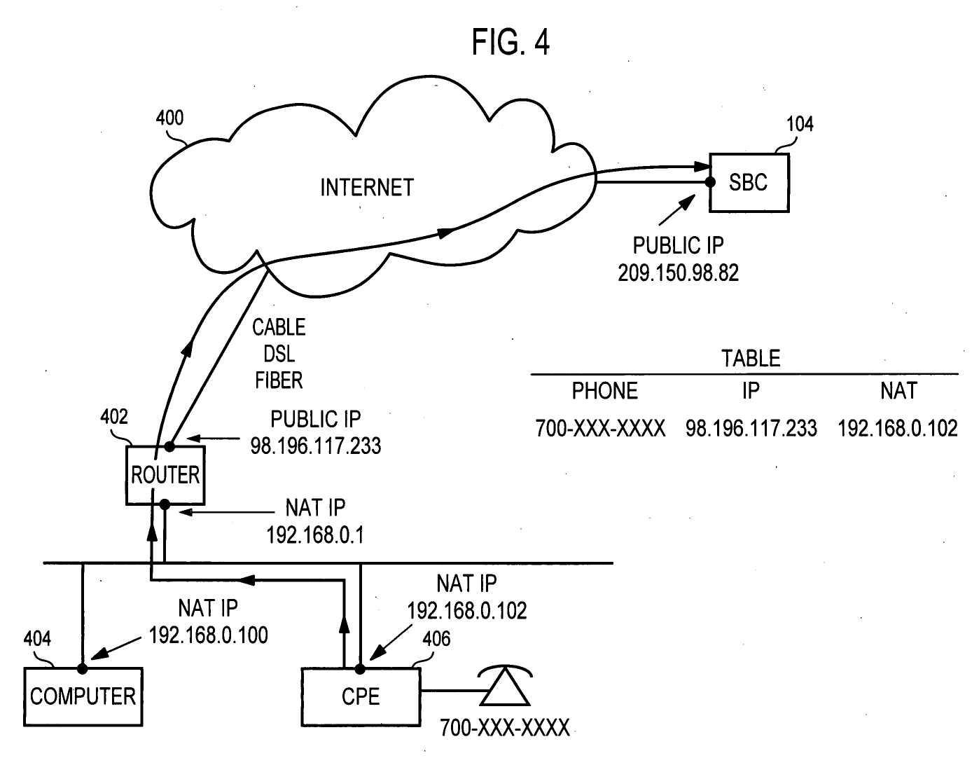

Referring to FIGS. 3 and 4, a DSL, cable, or fiber optics connection is terminated into a router 402 with a unique public IP address such as 98.196.117.233. The router 402 will also have a NAT IP address such as 192.168.0.1 that is not directly routable on the public Internet 400. Other computers 404 on the local network are given other NAT IP addresses. A personal computer 404 can, for example, be given the address of 192.168.0.100, and an analog telephone adapter CPE 406 can be given the address of 192.168.0.102.

When a device 406 102 192.168.0.102 behind the NAT IP address wants to communicate with public IP 209.150.98.82 on the Internet 400, it's packets must first be routed to the local default gateway 192.168.0.1 of the router 402. The router 402 with the NAT IP address then sends traffic to 209.150.98.82 using its public IP address 98.196.117.233 and maintains a connections table consisting of the NAT IP address and ports with its public IP address. If the SBC address 209.150.98.82 responds when this connection is open back to the router IP 98.196.117.233, the router 402 will translate the packets back to the CPE private IP of 192.168.0.102.

The SIP protocol typically uses REGISTER messages to authorize a CPE device 406 to use the VoIP network. This registration not only provides access control to the network, but also allows the SBC 104 keep a table that can be used to reach a CPE device 406. This registration table can comprise, but is not limited to, router IP addresses, phone numbers, and NAT IP addresses.

Referring again to FIG. 4, the SBC 104 is configured to ignore and not store any registration binding information for any CPE 406, including wireless devices. Accordingly, if a CPE 406 attempts to REGISTER to the SBC 104, such as in 10 minutes, the SBC 104 will not store any registration information and will not build a registration table with information about the CPE 406. Thus, the SBC 104 is unaware of the location or authorization of subscribers at any given time.

An inbound call to a subscriber using CPE 406; however, can still be processed normally until the call encounters the SBC 104 that routes traffic through the Internet 400 to the CPE 406. Then, the call waits by sending back 100 Trying because it does not know where the device is. In parallel, all wireless devices are configured to send messages, such as “OPTIONS messages,” every 2 seconds. Other standard SIP messages such as INFO, SUBSCRIBE, REGISTER (as long as no binding information is saved), or even custom messages could be used.

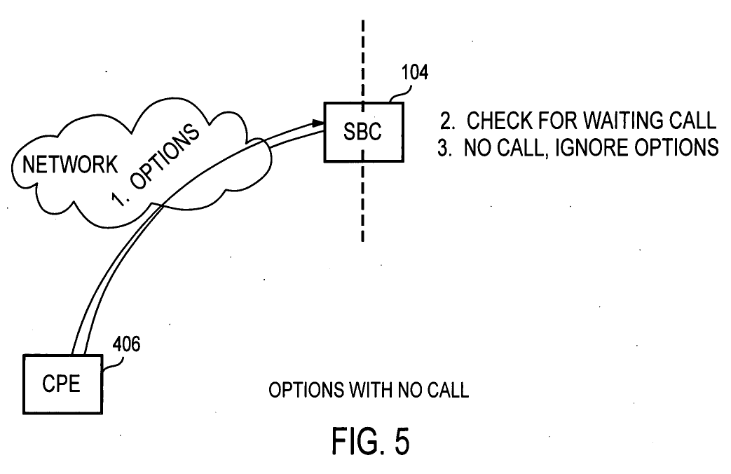

As OPTIONS messages are received by the SBC 104, the SBC 104 looks at each OPTIONS message and determines whether there is any call “holding” for that device. If there is not, the OPTIONS message is ignored. When an OPTIONS message is from a CPE 506 that is currently needed for an inbound call that is “on hold” at the SBC 104, the information from that OPTIONS message is then used to complete the call to the device. Another option occurs when there is an inbound call to a CPE 406 and there are no messages from the CPE 406 to the SBC 104. This circumstance can be handled by the SBC 104 sending back an SIP message or another internal device timing out on the signaling. The three main scenarios are covered in detail below with respect to FIGS. 5, 6, and 7.

OPTIONS with no Call (FIG. 5):

1. The CPE 406 sends OPTIONS to a programmed SBC 104 public IP address.

2. The SBC 104 checks for a waiting call from a private network.

3. If no call, then ignore OPTIONS.

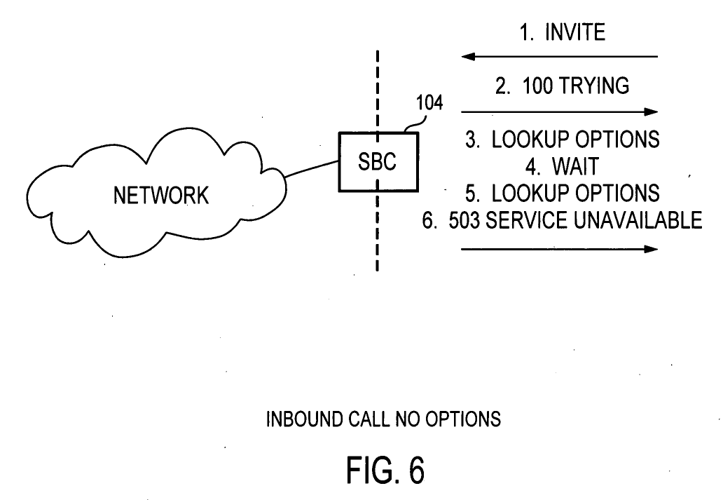

Inbound call no OPTIONS (FIG. 6):

1. INVITE from private network.

2. The SBC 104 sends back 100 Trying on the private network.

3. The SBC 104 looks for OPTIONS on the public network, none found.

4. Configurable wait timer.

5. The SBC 104 looks for OPTIONS on public network, none found.

6. The SBC 104 sends back SIP 503 Service Unavailable.

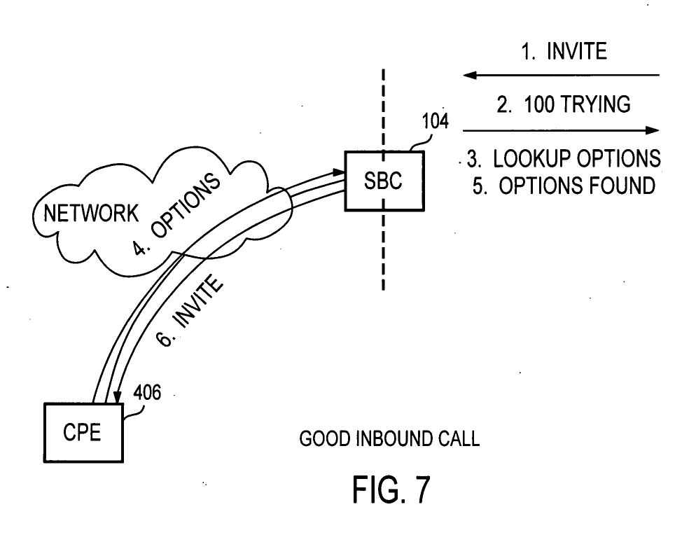

Good inbound call (FIG. 7):

1. INVITE from private network.

2. The SBC 104 sends back 100 Trying on the private network.

3. The SBC 104 looks for OPTIONS on public network.

4. The CPE 506 sends OPTIONS to programmed SBC 104 public IP address.

5. The SBC 104 receives OPTIONS from the CPE 406 with waiting Inbound call.

6. INVITE sent to public IP address of the CPE 406 or the NAT device.

With all the above scenarios, the private network never knows the public IP address of the CPE 406 or NAT device, and the CPE 406 never knows the IP addresses of any private VoIP network elements or public elements in the PSTN 108.

Although preferred embodiments of the present invention have been shown and described, it will be appreciated by those skilled in the art that changes can be made in these embodiments without departing from the principle and spirit of the invention, the scope of which is defined in the appended claims and their equivalents.

What is claimed is:

1. A network system for call processing, comprising:
customer premises equipment originating a call across a network, wherein the call includes private and public information;
a session border controller directing the call information from the customer premises equipment to a public switched telephone network gateway, wherein the session border controller parses out the private information from the call information transmitted to the gateway; and
one or more servers coupled to the session border controller, routing only the non-private call information to the public switched telephone network gateway.

2. The network according to claim 1, wherein the customer premises equipment includes one or more personal computers, analog telephone adapters, personal digital assistants, WiFi terminals, and/or IP phones

3. The network according to claim 1, wherein the call comprises statistics, messages, video, data, images, and multi-media.

4. The network according to claim 1, wherein the private information includes the internet protocol address and/or the telephone number of the customer premises equipment originating the call.

5. The network according to claim 1, wherein session border controller functions include network address translation, security, traffic shaping, and quality of service monitoring.

6. The network according to claim 1, wherein the servers include one or more routing servers, feature servers, and media servers.

7. The network according to claim 1, wherein the servers reside on a private network, and the customer premises equipment and the public switched telephone network gateway reside on one or more public networks.

8. The network according to claim 1, wherein:
the session border controller comprises at least a first session border controller and a second session border controller;
the first session border controller resides between the customer premises equipment and the one or more servers;
the second session border controller resides between the one or more servers and the public switched telephone network gateway;
the first session border controller blocks private information from being transmitted from the customer premises equipment to the one or more servers; and
the second session border controller blocks private information from being transmitted from the public switched telephone network gateway.

9. The network according to claim 8, wherein the private information blocked by the second session border controller includes one or more addresses of the public switched telephone network gateway.

10. A computer-implemented method for processing calls across a network, comprising:
initiating a call from customer premises equipment;
directing the call through a first session border controller, wherein the first session border controller blocks transmission of call private information;
transmitting the non-private call information through one or more servers of a private network to a second session border controller; and
forwarding the non-private call information from the second session border controller to a public switched telephone network gateway, wherein the second session border controller blocks the address of the public switched telephone network gateway from the private network.

11. The method according to claim 10, wherein the customer premises equipment is blocked from accessing a forwarded telephone number or a network address for a call destination.

12. The method according to claim 10, wherein the customer premises equipment can communicate only with the public side of the first session border controller and has no knowledge of the private network.

13. The method according to claim 10, wherein the one or more servers have no knowledge of the public switched telephone network gateway behind the second session border controller.
